(19) United States
(12) Patent Application Publication
(10) Pub. No.: US 2018/0337701 A1
(43) Pub. Date: Nov. 22, 2018

(54) SYSTEM FOR IMPROVING RECEIVED SIGNAL QUALITY

(71) Applicant: Wistron NeWeb Corporation, Hsinchu (TW)

(72) Inventors: Yan-Ming TSAI, Hsinchu (TW); Wei-Yu TSENG, Hsinchu (TW)

(21) Appl. No.: 15/674,694

(22) Filed: Aug. 11, 2017

(30) Foreign Application Priority Data
May 17, 2017 (TW) 106116309

(51) Int. Cl. H04B 1/10

(52) U.S. Cl. CPC H04B 1/1027; H04L 5/14

(57) ABSTRACT

A system includes a first antenna for receiving a signal, a first band duplexer coupled to the first antenna, a first receiving path selection circuit connected to the first band duplexer configured to provide a first path and a second path, and a control circuit connected to the first path and the second path. The control circuit controls the first receiving path selection circuit to obtain receiving signal parameters from the first path and the second path, respectively. The control circuit selects a receiving path according to the receiving signal parameters from the first path and the second path. The receiving path is one of the first path or the second path, and is the path having a desired or optimum receiving signal parameter.

### CROSS-REFERENCE TO RELATED APPLICATION

The present application claims priority to Taiwan Application No. 106116309, filed May 17, 2017, the contents of which are incorporated herein by reference.

### BACKGROUND OF THE INVENTION

### 1. Field of the Invention

The present invention generally relates to a system and in particular to a system for improving received signal quality.

### 2. Description of Related Art

At present, wireless mobile devices in the commercial market must pass a test measuring the radiation performance of the device. The test measures the radiation of the wireless mobile device to obtain the transmission power and the reception sensitivity. In this regard, the quality of the received signal is an important factor for users to operate wireless mobile devices.

Therefore, there is a desire to develop systems having improved signal quality.

### SUMMARY OF THE INVENTION

As embodiment of the present invention is directed to a system for improving received signal quality. The system includes a first antenna for receiving a signal, a first band duplexer coupled to the first antenna, a first receiving path selection circuit connected to the first band duplexer for providing a first path and a second path, and a control circuit connected to the first path and the second path. The control circuit controls the first receiving path selection circuit to obtain receiving signal parameters from the first path and the second path, respectively. The control circuit selects a receiving path according to receiving signal parameters from the first path and the second path. The selected receiving path is one of the first path or the second path.

Further features of the invention, its nature, and various advantages will be apparent from the accompanying drawings and the following detailed description of the preferred embodiments.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a block diagram of an embodiment of a system constructed in accordance with the principles of the present invention;

FIG. 2 is a block diagram of another embodiment of a system constructed in accordance with the principles of the present invention.

FIG. 3 is a diagram of illustrative antenna switching circuit in accordance with an embodiment of the invention.

FIG. 4 is a diagram of illustrative band switching circuit in accordance with an embodiment of the invention.

FIG. 5 is a block diagram of illustrative RF transceiving circuit in accordance with an embodiment of the invention.

FIG. 6 is a block diagram of illustrative baseband controller in accordance with an embodiment of the invention.

### DETAILED DESCRIPTION OF THE PREFERRED EMBODIMENTS

The structure and technical features of the present invention will now be described in detail with reference to certain embodiments and the accompanying drawings thereof, so that the present invention can be easily understood.

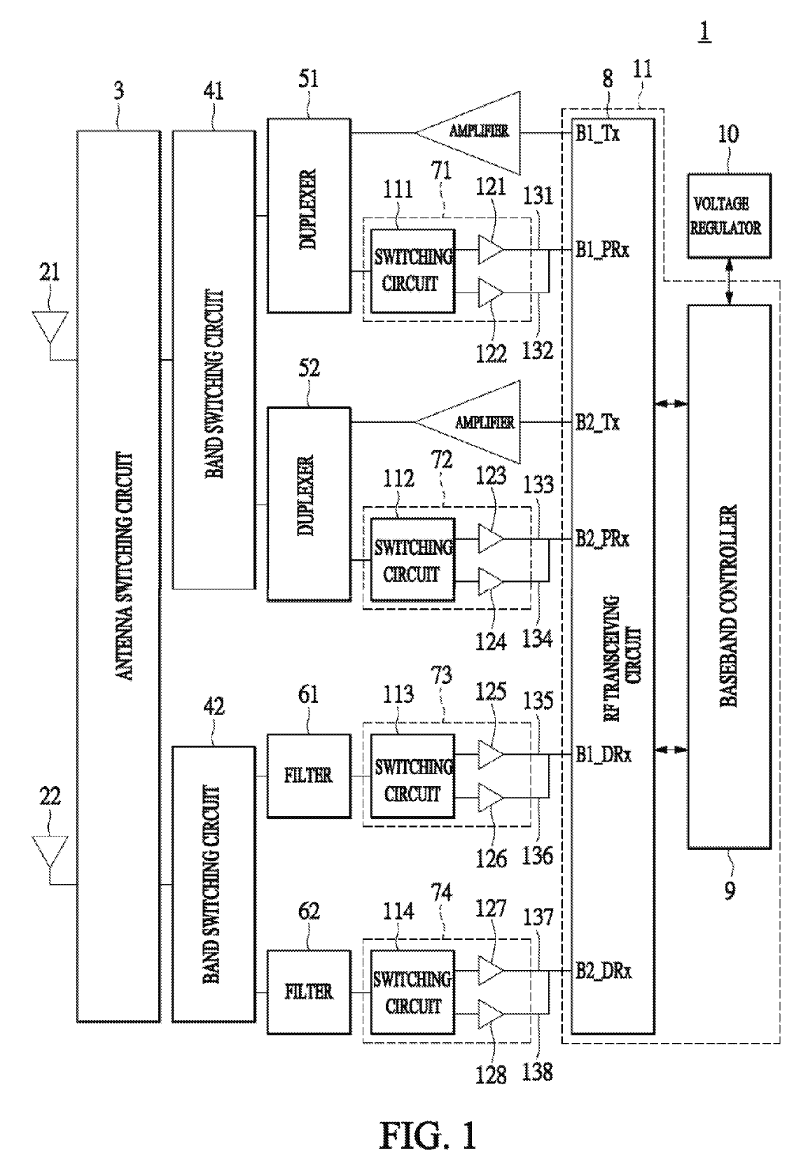

FIG. 1 is a block diagram of a system for improving received signal quality in accordance with an embodiment of the present invention. The system 1 includes antennas 21 and 22, an antenna switching circuit 3, band switching circuits 41 and 42, duplexers 51 and 52, filters 61 and 62, receiving path selection circuits 71 to 74, a voltage regulator 10, and a control circuit 11. The duplexers 51 and 52 support the first frequency band B1 and the second frequency band B2, respectively. The filters 61 and 62 support the first frequency band B1 and the second frequency band B2, respectively. The control circuit 11 includes a radio frequency (RF) transceiving circuit 8 and baseband controller 9. The receiving path selection circuits 71 to 74 include switching circuits 111 to 114 and low-noise amplifiers (LNA) 121 to 128. The antennas 21 and 22 are connected to an antenna switching circuit 3. The antenna switching circuit 3 is connected to the band switching circuits 41 and 42. The band switching circuits 41 and 42 are connected to the duplexers 51 and 52 and to the filters 61 and 62. The band switching circuit 41 may switch the duplexers 51, 52 to determine the operation frequency band. The band switching circuit 42 may switch the filters 61, 62 to determine the operation frequency band. The duplexer 51 and 52 are connected to the receiving path selection circuits 71 and 72, respectively. The filters 61 and 62 are connected to the receiving path selection circuits 73 and 74, respectively. The receiving path selection circuits 71 to 74 are connected the control circuit 11. The RF transceiving circuit 8 is connected to the baseband controller 9. The control circuit 11 is connected to the voltage regulator 10. The voltage regulator 10 is connected to the LNA 121 to 128.

Furthermore, the duplexers 51 and 52 are connected to the switching circuits 111 and 112, respectively. The filters 61 and 62 are connected to the switching circuits 113 and 114. The switching circuit 111 is connected to the LNA 121 and 122. The switching circuit 112 is connected to the LNA 123 and 124. The switching circuit 113 is connected to the LNA 125 and 126. The switching circuit 114 is connected to the LNA 127 and 128. LNA 121 and 122 are disposed on the paths 131 and 132, respectively, and connected to a first frequency band primary receiving node B1_PRx of control circuit 11. LNA 123 and 124 are disposed on the paths 133 and 134, respectively, and connected to a second frequency band receiving node B2_PRx of control circuit 11. LNA 125 and 126 are disposed on the paths 135 and 136, respectively, and connected to a first frequency band diversity receiving node B1_DRx of control circuit 11. LNA 127 and 128 are disposed on the paths 137 and 138, respectively, and connected to a second frequency band diversity receiving node B2_DRx of control circuit 11. As will be understood by person skilled in the art, if a path is located near an interference source, for example near a high frequency oscillator, the receiving signal quality of the path is poor. To combat this, m multiple receiving paths are provided in the present invention. Different paths may have different trace lengths, widths, and positions on the printed circuit board (PCB). In some embodiments, if the PCB is a multilayer structure, different paths can be disposed on different layers of the PCB. Thus, different receiving paths generally exhibit different receiving signal parameters. In addition, the LNAs disposed on each path are identical, that is, each LNA has the same characteristics.

The paths 131 to 138 are provided between the antennas 21 and 22 and the receiving nodes of the RF transceiving circuit 8. The path 131 includes the antenna switching circuit 3, the band switching circuit 41, the duplexer 51, the switching circuit 111 and LNA 121. The path 132 includes the antenna switching circuit 3, the band switching circuit 41, the duplexer 51, the switching circuit 111 and LNA 122. The path 133 includes the antenna switching circuit 3, the band switching circuit 41, the duplexer 52, the switching circuit 112 and LNA 123. The path 134 includes the antenna switching circuit 3, the band switching circuit 41, the duplexer 52, the switching circuit 112 and LNA 124. The path 135 includes the antenna switching circuit 3, the band switching circuit 42, the filter 61, the switching circuit 113 and LNA 125. The path 136 includes the antenna switching circuit 3, the band switching circuit 42, the filter 61, the switching circuit 113 and LNA 126. The path 137 includes the antenna switching circuit 3, the band switching circuit 42, the filter 62, the switching circuit 114 and LNA 127. The path 138 includes the antenna switching circuit 3, the band switching circuit 42, the filter 62, the switching circuit 114 and LNA 128. In addition, all paths may be provided with antenna 21 or antenna 22 to form a receiving path.

It should be noted that the above-described embodiments are merely examples in which the number of paths can be increased or decreased according to the number of antennas and the number of receiving nodes of the RF transceiving circuit 8. Persons skilled in the art can design the number of antennas and the number of receiving nodes of the RF transceiving circuit in accordance with varying system specifications. Therefore, the present invention is not limited to the above-described embodiments.

With reference to FIG. 1, in one embodiment, when the system 1 receives signals by utilizing the antenna 21, the antenna switching circuit 3, the band switching circuit 41, the duplexers 51 and the receiving path selection circuits 71, the control circuit 11 controls the receiving path selection circuits 71 to obtain the receiving signal parameters from the paths 131 and 132, respectively. The control circuit 11 selects a desired receiving path (i.e., selected receiving path) according to the receiving various signal parameters from the paths 131 and 132. The selected receiving path is one of the paths 131 or 132 and has optimum receiving signal parameter.

With reference to FIG. 1, in one embodiment, when the system 1 receives signals by utilizing the antenna 21, the antenna switching circuit 3, the band switching circuit 41, the duplexers 51 and 52 and the receiving path selection circuits 71 and 72, the control circuit 11 controls the receiving path selection circuits 71 and 72 to obtain the receiving signal parameters from the paths 131 to 134, respectively. The control circuit 11 selects a desired receiving path according to the receiving signal parameters from the paths 131 to 134. The selected receiving path is one of the paths 131 to 134 and has optimum receiving signal parameter.

With reference to FIG. 1, in one embodiment, when the system 1 receives signals by utilizing the antenna 21, the antenna switching circuit 3, the band switching circuit 41, the duplexers 51 and 52 and the receiving path selection circuits 71, 72 and 73, the control circuit 11 controls the receiving path selection circuits 71, 72 and 73 to obtain the receiving signal parameters from the paths 131 to 136, respectively. The control circuit 11 selects a desired receiving path according to the receiving signal parameters from the paths 131 to 136. The selected receiving path is one of the paths 131 to 136 and has optimum receiving signal parameter.

With reference to FIG. 1, in one embodiment, when the system 1 receives signals by utilizing the antenna 21, the antenna switching circuit 3, the band switching circuit 41, the duplexers 51 and 52 and the receiving path selection circuits 71, 72, 73 and 74, the control circuit 11 controls the receiving path selection circuits 71, 72, 73 and 74 to obtain the receiving signal parameters from the paths 131 to 138, respectively. The control circuit 11 selects a desired receiving path according to the receiving signal parameters from the paths 131 to 138. The selected receiving path is one of the paths 131 to 138 and has optimum receiving signal parameter.

With reference to FIG. 1, in one embodiment, when the system 1 receives signals by utilizing the antennas 21 and 22, the antenna switching circuit 3, the band switching circuit 41, the duplexer 51 and the receiving path selection circuit 71, the control circuit 11 controls the antenna switching circuit 3 to switch the antenna 21 and the antenna 22 and selects a desired receiving path according to the receiving signal parameters, corresponding to the antenna 21, from the paths 131 and 132 and the receiving signal parameters, corresponding to the antenna 22, from the paths 131 and 132. The selected receiving path includes one of the antennas 21 or 22 and one of the paths 131 or 132. In addition, the selected receiving path is the one having optimum receiving signal parameter.

With reference to FIG. 1, in one embodiment, when the system 1 receives signals by utilizing the antennas 21 and 22, the antenna switching circuit 3, the band switching circuit 41, the duplexers 51 and 52 and the receiving path selection circuits 71 and 72, the control circuit 11 controls the antenna switching circuit 3 to switch the antennas 21 and 22 and controls the band switching circuit 41 to switch duplexers 51 and 52. The control circuit 11 controls the antenna switching circuit 3, the band switching circuit 41 and the receiving path selection circuits 71 and 72 to select a desired receiving path (e.g., selected receiving path). The selected receiving path includes one of the antennas 21 or 22, one of the duplexers 51 or 52, and one of the paths 131 to 134. In addition, the selected receiving path is the one having optimum receiving signal parameter.

With reference to FIG. 1, in one embodiment, when the system 1 receives signals by utilizing the antennas 21 and 22, the antenna switching circuit 3, the band switching circuits 41 and 42, the duplexers 51 and 52, the filter 61 and the receiving path selection circuits 71, 72 and 73, the control circuit 11 controls the antenna switching circuit 3 to switch the antennas 21 and 22 and controls the band switching circuits 41 and 42 to switch duplexers 51, 52 and the filter 61. The control circuit 11 controls the antenna switching circuit 3, the band switching circuits 41 and 42 and the receiving path selection circuits 71, 72 and 73 to select a desired receiving path. The selected receiving path includes one of the antennas 21 or 22, one of the duplexers 51, 52 and the filter 61, and one of the paths 131 to 136. In addition, the selected receiving path is the one having optimum receiving signal parameter.

With reference to FIG. 1, in one embodiment, when the system 1 receives signals by utilizing the antennas 21 and 22, the antenna switching circuit 3, the band switching circuits 41 and 42, the duplexers 51 and 52, the filters 61 and 62 and the receiving path selection circuits 71, 72, 73 and 74, the control circuit 11 controls the antenna switching circuit 3 to switch the antennas 21 and 22 and controls the band switching circuits 41 and 42 to switch duplexers 51, 52, the filters 61 and 62. The control circuit 11 controls the antenna switching circuit 3, the band switching circuits 41 and 42 and the receiving path selection circuits 71, 72, 73 and 74 to select a desired receiving path. The selected receiving path includes one of the antennas 21 or 22, one of the duplexers 51, 52, the filters 61 and 62, and one of the paths 131 to 138. In addition, the receiving path is the one having optimum receiving signal parameter.

The receiving signal parameter may be any of a variety of signal parameters reflective of signal quality. For example, the receiving signal parameter may be the Signal-to-Interference plus Noise Ratio (SINR) value of the received signals on the paths 131-138, the automatic gain control (AGC) value of the received signals on the paths 131-138, or the combination of SINR and AGC values of the received signals on the paths 131-138. It should be noted that since the RF transceiving circuit 8 transmits the received signals to the baseband controller 9 for further processing. The AGC parameter is that the baseband controller 9 adjusts a gain adjustment value of the received signals from RF transceiving circuit 8. As will be appreciated by persons skilled in the art, the receiving signal parameter may be the product of the SINR value and the AGC value, the sum of 10 times the SINR value and the AGC value, or the sum the SINR value and one tenth of the AGC value. In addition to the above embodiments, a person skilled in the art can obtain the receiving signal parameter based on a variety of mathematical functions of SINR value and AGC value. The present invention is not limited to the use of any particular receiving signal parameter in determining a desired or optimum receive path.

In one embodiment, when the control circuit 11 determines the path 131 and the antenna 21 as selected receiving path according to the receiving signal parameters from the paths 131-138 in the system 1, the control circuit 11, through the voltage regulator 10, may adjust the operating voltage of the LNA 121, which is disposed on the receiving path 131, for increasing the power gain of the LNA 121. For example, the default value of the operating voltage of the LNA 121 is 3.3 V, and the baseband controller 9 adjusts the operating voltage of the LNA 121 to 3.8 V so that the power gain of the LNA 121 may be increased by about 0.2-0.5 dB to improve the received signal quality. It should be noted that those skilled in the art may adjust the operating voltage of the LNA in accordance with the system requirements, and the present invention is not limited thereto.

One example is provided that the system 1 receives signals by utilizing the antennas 21 and 22, the antenna switching circuit 3, the duplexer 51, and the receiving path selection circuit 71. The transmission frequency (TX Frequency) band of the Long Term Evolution (LTE) operation is 1920 to 1980 MHz and the reception frequency (RX Frequency) band is 2110 to 2170 MHz, the receiving signal parameter, in this example, of the path is Yi=SINR *|AGC|, i.e., the product of SINR value and the absolute value of AGC value. Corresponding to the antenna 21 and the path 131 the SINR value is 10 dB and the AGC value is −200. Corresponding to the antenna 21 and the path 132, the SINR value is 20 dB and the AGC value is −250. Corresponding to the antenna 22 and the path 131, the SINR value of is 15 dB and the AGC value is −130. Corresponding to the antenna 22 and the path 132, the SINR value is 25 dB and the AGC value is −180. The four receiving signal parameters Yi are 2000,5000,1950,4500. In this embodiment, the larger SINR value and the larger the absolute value of the AGC value represent the better the reception quality. The control circuit 11 may take the antenna 21 and the path 132, having the optimum receiving signal parameter (5000), in the four receiving signal parameters as the selected receiving path. Furthermore, the control circuit 11 may adjust the operating voltage of the LNA 122 which is disposed on the receiving path 132 having the optimum receiving signal parameter for increasing the power gain and achieving better reception signal quality.

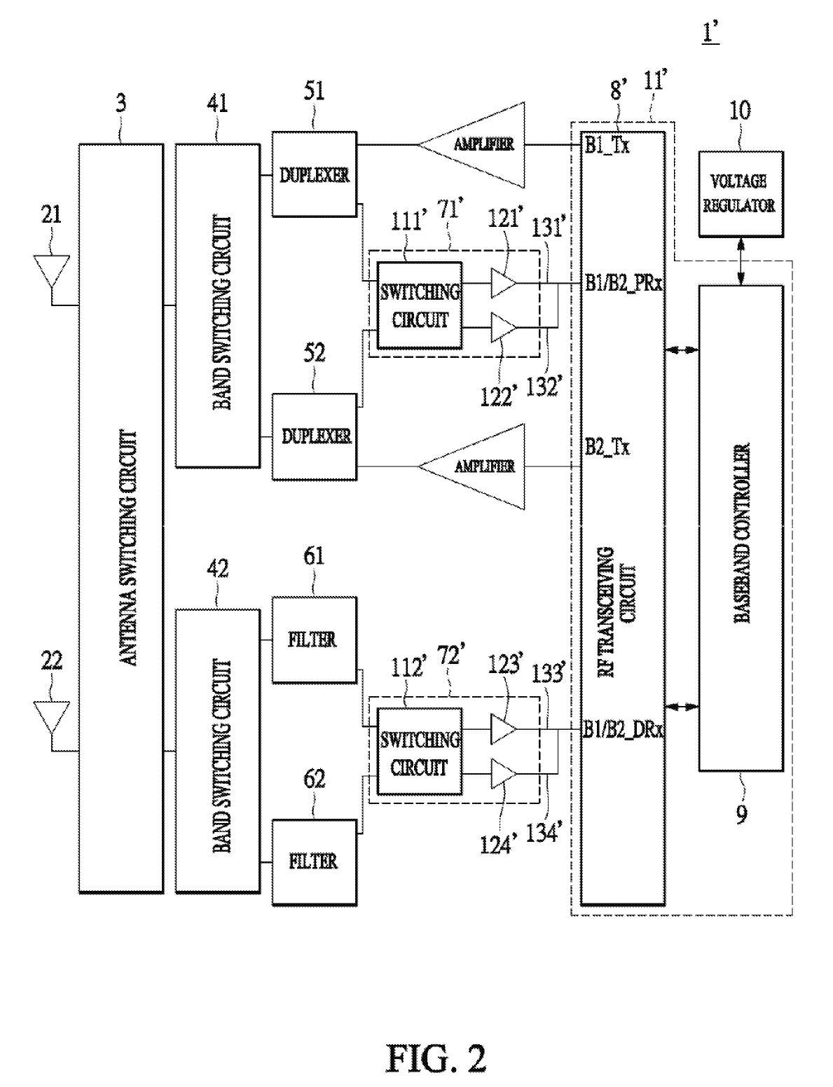

FIG. 2 is a block diagram of the system, in accordance with another embodiment of the present invention. The difference between the system 1′ of this embodiment and the system 1 of the previous embodiment is that the number of receiving nodes of the RF transceiving circuit 8′ and the number of receiving path selection circuits are different. Since the receiving node of the transceiving circuit 8′ may support two adjacent reception bands so that the two adjacent reception bands may share one receiving node. Thus, the system 1′ of the present embodiment may reduce the number of receiving path selection circuits. It should be noted that the center frequencies of the two adjacent bands are no more than 100 MHz. For example, the band B1 and the band B2 are two adjacent bands, so that the band B1 and the band B2 may share a receiving node B1/B2_PRx. Also, the band B1 and the band B2 may share a receiving node B1/B2_DRx. Thus, the system 1′ of this embodiment includes the receiving path selection circuits 71′, 72′ and the paths 131′-134′. The receiving path selection circuit 71′ includes a switching circuit 111′ and LNA 121′ and 122′. The receiving path selection circuit 72′ includes a switching circuit 112′ and LNA 123′ and 124′. The elements operation of system 1′ of this embodiment is similar to the system 1 of the previous embodiment, and thus is omitted herein for the sake of brevity.

With reference to FIG. 2, in one embodiment, the system 1′ receive signals by utilizing the antennas 21 and 22, the antenna switching circuit 3, the duplexer 51, and the receiving path selection circuit 71′. The control circuit 11′ controls the antenna switching circuit 3 to switch the antennas 21 and 22 and select a desired receiving path according to the receiving signal parameters, corresponding to the antenna 21, from the paths 131′ and 132′. The selected receiving path includes one of the antennas 21 and 22 and one of the paths 131′ and 132′. In addition, the selected receiving path is the one having optimum receiving signal parameter.

With reference to FIG. 2, in one embodiment, when the system 1′ receives signals by utilizing the antennas 21 and 22, the antenna switching circuit 3, the band switching circuit 41, the duplexers 51 and 52 and the receiving path selection circuits 71′, the control circuit 11′ controls the antenna switching circuit 3 to switch the antennas 21 and 22 and controls the band switching circuit 41 to switch duplexers 51 and 52. The control circuit 11 controls the antenna switching circuit 3, the band switching circuit 41 and the receiving path selection circuits 71′ to select a desired receiving path. The selected receiving path includes one of the antennas 21 or 22, one of the duplexers 51 or 52, and one of the paths 131′ or 132′. In addition, the selected receiving path is the path having optimum receiving signal parameter.

With reference to FIG. 2, in one embodiment, when the system 1′ receives signals by utilizing the antennas 21 and 22, the antenna switching circuit 3, the band switching circuits 41 and 42, the duplexers 51 and 52, the filters 61 and 62 and the receiving path selection circuits 71′ and 72′, the control circuit 11 controls the antenna switching circuit 3 to switch the antennas 21 and 22 and controls the band switching circuits 41 and 42 to switch duplexers 51, 52, the filters 61 and 62. The control circuit 11 controls the antenna switching circuit 3, the band switching circuits 41 and 42 and the receiving path selection circuits 71′ and 72′ to select a desired receiving path. The selected receiving path includes one of the antennas 21 and 22, one of the duplexers 51, 52, the filters 61 and 62, and one of the paths 131′-134′. In addition, the selected receiving path is the path having optimum receiving signal parameter.

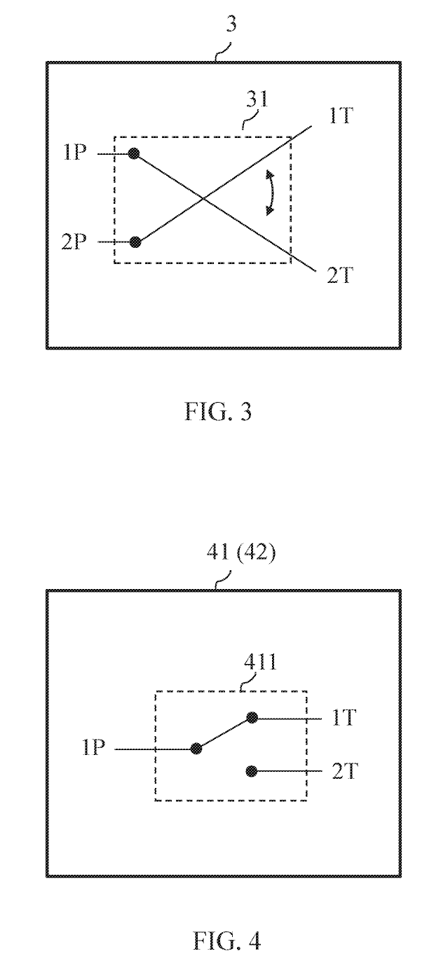

FIG. 3 is a diagram of the antenna switching circuit 3. The antenna switching circuit 3 includes a switch 31. As shown in FIG. 3, in one embodiment, the switch 31 is a double pole double throw, DPDT, switch. The inputs 1P and 2P may be coupled to the antenna 21 and 22, respectively. The outputs 1T and 2T may be coupled to the band switching circuit 41 and 42, respectively. The inputs 1P and 2P may be interchangeably switched to the outputs 1T or 2T.

FIG. 4 is a diagram of the band switching circuits 41 and 42. The band switching circuits 41 or 42 includes a switch 411. As shown in FIG. 4, in one embodiment, the switch 411 is a single pole double throw, SPDT, switch. The input of the switch 411 is coupled to the output of antenna switching circuit 3. The two outputs of the switch 411 are coupled to the duplexers 51 and 52, or the filters 61 and 62. The control circuit 11 or 11′ may control the switch 411 of the band switching circuit 41 to switch the duplexers 51 and 52. Similarly, the control circuit 11 or 11′ may control the switch 411 of the band switching circuit 42 to switch the filters 61 and 62. According to the above descriptions, with reference to FIG. 1, the selected receiving path may be a combination of one of the antenna 21 and 22, one of the band switching circuits 41 and 42, one of the duplexers 51, 52, the filters 61 and 62, and one of the LNA 121 to 128.

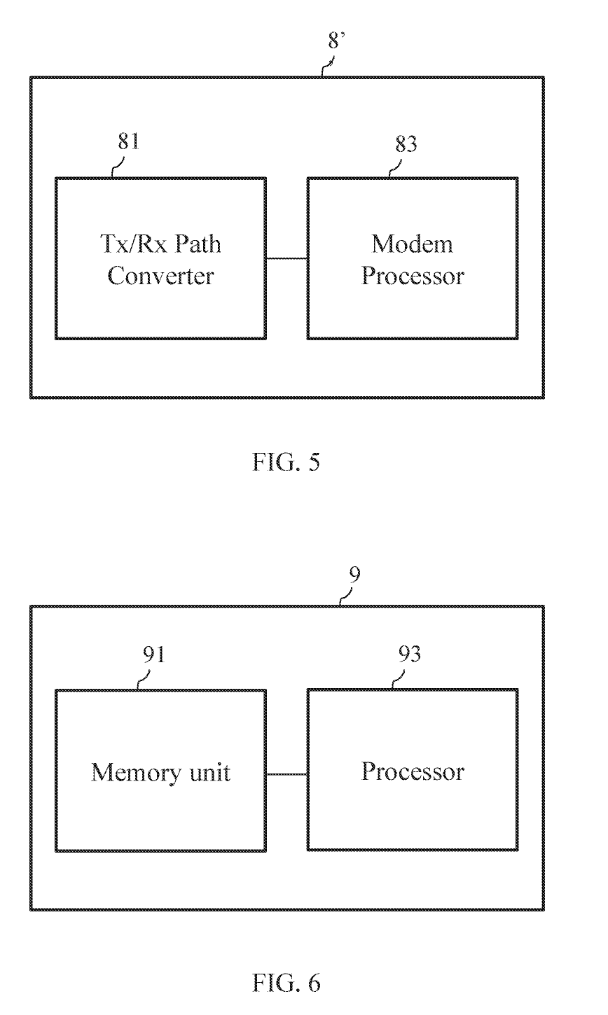

FIG. 5 is a block diagram of the RF transceiving circuit 8 and 8′. The RF transceiving circuit 8 or 8′ includes a Tx/Rx path converter 81 and a Modem processor 83. The Tx/Rx path converter 83 may perform frequency up-conversion and down-conversion on Tx signals and Rx signals thereby transforming RF signal to baseband signal or transforming baseband signal to RF signal. The modem processor may receive analog signals from the Tx/Rx path converter 81 and convert the analog signals to digital signals then transmitting to the baseband controller 9.

FIG. 6 is a block diagram of the baseband controller 9. The baseband controller 9 includes a memory unit (e.g., memory circuit) 91 and a processor 93. In one embodiment, referring to the FIG. 1, a program code is stored in the memory unit 91 and may instruct the processor 93 to control the antenna switching circuit 3, the band switching circuits 41 and 42 and the switching circuits 111 to 114, the voltage regulator 10. The program code may instruct the processor 93 to select a desired receiving path according to the receiving signal parameter from multiple paths. In another embodiment, the memory unit 91 and processor 93 may be implemented in the RF transceiving circuit 8 or 8′.

It will be appreciated by persons skilled in the art that the system of the present invention for improving received signal quality determines the number of antennas, antenna switching circuits, band switching circuits, duplexers, filters and receiving path selection circuits according to desired design requirements, and determines the selected receiving path and antenna according to a desired or optimum receiving signal parameter. Furthermore, adjusting the operating voltage of LNA, which is disposed on the receiving path, for increasing power gain and achieving better reception quality is also provided in embodiments of the present invention.

Although embodiments of the present invention have been described in detail with reference to certain preferred embodiments thereof, other embodiments are possible. Therefore, their spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for improving received signal quality, comprising:
a first antenna for receiving signals;
a first band duplexer, electrically connected to the first antenna;
a first receiving path selection circuit, connected to the first band duplexer and configured to provide a first path and a second path; and
a control circuit, connected to the first path and the second path;
wherein the control circuit controls the first receiving path selection circuit to obtain a receiving signal parameter from each of the first path and the second path, wherein the control circuit further selects a desired receiving path according to the receiving signal parameters from the first path and the second path, and wherein the selected receiving path is one of the first path or the second path.

2. The system of claim 1, further comprising:
a second antenna for receiving signals; and
an antenna switching circuit, connected to the first antenna and the second antenna and coupled to the first band duplexer;
wherein the control circuit controls the antenna switching circuit to switch the first antenna and the second antenna and determines the selected receiving path according to the receiving signal parameters, corresponding to the first antenna, from the first path and the second path and the receiving signal parameters, corresponding to the second antenna, from the first path and the second path; wherein one of the first antenna and the second antenna and one of the first path and the second path form the selected receiving path.

3. The system of claim 2, further comprising:
a first band switching circuit, connected between the antenna switching circuit and the first band duplexer; and
a second band duplexer, connected to the first band switching circuit and the first receiving path selection circuit;
wherein the first band switching circuit is configured to switch the first band duplexer and the second band duplexer, and wherein one of the first antenna and the second antenna, one of the first band duplexer and the second band duplexer, and one of the first path and the second path form the selected receiving path.

4. The system of claim 3, further comprising:
a second band switching circuit, connected to the antenna switching circuit;
a first band filter, connected to the second band switching circuit;
a second band filter, connected to the second band switching circuit; and
a second receiving path selection circuit, connected to the first band filter and the second band filter and providing a third path and a fourth path, which are connected to the control circuit;
wherein the second band switching circuit is configured to switch the first band filter and the second band filter, and wherein the control circuit controls the second receiving path selection circuit to obtain the receiving signal parameters from the third path and fourth path, respectively, and determines the selected receiving path according to the receiving signal parameters from the first path, second path, third path, and fourth path; wherein one of the first antenna and the second antenna, one of the first band duplexer, the second band duplexer, the first band filter, and the second band filter, and one of the first path, second path, third path, and fourth path form the selected receiving path.

5. The system of claim 1, wherein the first receiving path selection circuit further comprising:
a first switching circuit configured to switch between the first path and the second path;
a first low-noise amplifier, disposed on the first path; and
a second first low-noise amplifier, disposed on the second path.

6. The system of claim 1, further comprising:
a first band switching circuit, connected to the first band duplexer;
a second band duplexer, connected to the first band switching circuit; and
a second receiving path selection circuit, connected to the second band duplexer and providing a third path and a fourth path connected to the control circuit;
wherein the control circuit controls the second receiving path selection circuit to obtain the receiving signal parameters from the third path and the fourth path, respectively, and determines the selected receiving path according to the receiving signal parameters from the first, second, third, and fourth path; wherein the selected receiving path is one of the first path, second path, third path, or fourth path.

7. The system of claim 6, wherein the second receiving path selection circuit further comprises:
a second switching circuit configured to switch between the third path and the fourth path;
a third low-noise amplifier, disposed on the third path; and
a fourth low-noise amplifier, disposed on the fourth path.

8. The system of claim 6, further comprising:
a second band switching circuit;
a first band filter, connected to the second band switching circuit; and
a third receiving path selection circuit, connected to the first band filter and providing a fifth path and a sixth path connected to the control circuit;
wherein the control circuit controls the third receiving path selection circuit to obtain the receiving signal parameters from the fifth path and the sixth path, respectively, and determines the selected receiving path according to the receiving signal parameters from the first path, second path, third path, fourth path, fifth path, and sixth path; wherein the selected receiving path is one of the first, second, third, fourth, fifth, or sixth paths.

9. The system of claim 8, wherein the third receiving path selection circuit further comprises:
a third switching circuit configured to switch between the fifth path and the sixth path;
a fifth low-noise amplifier, disposed on the fifth path; and
a sixth low-noise amplifier, disposed on the sixth path.

10. The system of claim 8, further comprising:
a second band filter, connected to the second band switching circuit; and
a fourth receiving path selection circuit, connected to the second band filter and providing a seventh path and a eighth path connected to the control circuit;
wherein the control circuit controls the fourth receiving path selection circuit to obtain the receiving signal parameters from the seventh path and the eighth path, respectively, and determines the selected receiving path according to the receiving signal parameters from the first path, second path, third path, fourth path, fifth path, sixth path, seventh path, and eighth path;
wherein the receiving path is one of the first path, second path, third path, fourth path, fifth path, sixth path, seventh path, or eighth path.

11. The system of claim 10, wherein the fourth receiving path selection circuit further comprises:
a fourth switching circuit configured to switch between the seventh path and the eighth path;
a seventh low-noise amplifier, disposed on the seventh path; and
a eighth low-noise amplifier, disposed on the eighth path.

12. The system of claim 1, further comprising a voltage regulator connected to the control circuit, and wherein the voltage regulator adjusts an operating voltage of a low-noise amplifier disposed on the selected receiving path.

13. The system of claim 1, wherein the receiving signal parameters from the first path and the second path are SINR values.

14. The system of claim 1, wherein the receiving signal parameters from the first path and the second path are AGC values.

15. The system of claim 1, wherein the receiving signal parameters from the first path and the second path are functions of an SINR value and an AGC value.

16. The system of claim 1, wherein the selected receiving path has an optimum receiving signal parameter.
